(19) United States
(12) Patent Application Publication
(10) Pub. No.: US 2026/0311716 A1
(43) Pub. Date: Oct. 8, 2026

(54) METHOD AND DEVICE FOR GENERATING SPEECH ENHANCEMENT MODEL, AND SPEECH ENHANCEMENT METHOD AND DEVICE

(71) Applicant: Orka Health Co., Ltd., Shanghai (CN)

(72) Inventors: Congxi LU, Shanghai (CN); Linkai LI, Shanghai (CN); Haoshuai ZHOU, Shanghai (CN); Yufan YUAN, Shanghai (CN); Hongcheng SUN, Shanghai (CN)

(21) Appl. No.: 18/725,147

(22) PCT Filed: Dec. 13, 2022
(86) PCT No.: PCT/CN2022/138735

§ 371 Date: Jun. 28, 2024

(30) Foreign Application Priority Data
Dec. 28, 2021 (CN) 202111623706.X

(51) Int. Cl. G10L 21/0208; G06N 3/044; G06N 3/0464; G06N 3/08

(52) U.S. Cl. CPC G10L 21/0208; G06N 3/044; G06N 3/0464; G06N 3/08

(57) ABSTRACT

The present application discloses a method for generating a speech enhancement model, including: obtaining audio training data; obtaining a first model and a second model, where the first model is a deep neural network model, and resources occupied by the second model during operation is less than that occupied by the first model; training the first model and the second model based on the audio training data, where the training includes: obtaining first audio data having a frame length of M from the input audio; inputting the first audio data into the first model for processing to obtain a first output result; obtaining second audio data having a frame length of N from the input audio, where the second audio data is subsequent to the first audio data, and N<M; inputting the second audio data and the first output result into the second model for processing to obtain a second output result; and updating parameters of the first model and parameters of the second model based on the second output result and output audio to obtain a trained first model and a trained second model; and generating a speech enhancement model based on the trained first model and the trained second model.

### TECHNICAL FIELD

The present application relates to audio processing technologies, and more particularly, to a method and a device for generating a speech enhancement model, and a method and a device for speech enhancement.

### BACKGROUND OF THE INVENTION

Speech enhancement refers to techniques of suppressing or reducing noise interferences and extracting desired speech signals from audio signals when the speech signals are interfered with or even submerged by various types of noises. Speech enhancement is widely used in fields such as mobile phones, videoconferencing or teleconferencing systems, speech recognition, and hearing aids. In recent years, with the widespread use of neural network technologies, deep neural network technologies have been applied in speech enhancement and brought significant improvements to the speech enhancement technologies. However, a conventional deep neural network model usually requires an audio having a frame length of more than 8 milliseconds (for example, 10 milliseconds or 16 milliseconds) as input, and the frame length plus a delay of the algorithm itself makes the total delay exceed 20 milliseconds. Due to the excessively long delay, the deep neural network model cannot be applied to devices with high real-time performance requirements (for example, hearing aids). In addition, the high computational load of the deep neural network model also limits its application to low-power devices.

Therefore, it is necessary to provide a speech enhancement model to solve the above-mentioned problems existing in the prior art.

### SUMMARY OF THE INVENTION

An objective of the present application is to provide a method and device for generating a speech enhancement model, and a method and device for performing speech enhancement using the speech enhancement model, which have the characteristics of low power consumption and low delay.

In an aspect of the present application, a method for generating a speech enhancement model is provided. The method for generating a speech enhancement model includes: obtaining audio training data, where the audio training data includes noisy input audio data and noiseless output audio data corresponding to the noisy input audio data; obtaining a first model and a second model, where the first model is a deep neural network model, and resource occupation of the second model during operation is less than that occupied by the first model; training the first model and the second model based on the audio training data, where the training includes: obtaining first audio data having a frame length of M from input audio; inputting the first audio data into the first model for processing to obtain a first output result; obtaining second audio data having a frame length of N from the input audio, where the second audio data is subsequent to the first audio data, and N<M; inputting the second audio data and the first output result into the second model for processing to obtain a second output result; and updating parameters of the first model and parameters of the second model based on the second output result and the output audio to obtain a trained first model and a trained second model; and generating a speech enhancement model based on the trained first model and the trained second model.

In another aspect of the present application, a device for generating a speech enhancement model is further provided. The device for generating a speech enhancement model includes: a processor; and a storage apparatus, configured to store a computer program executable on the processor, where the computer program, when executed by the processor, causes the processor to perform the above-mentioned method for generating a speech enhancement model.

In another aspect of the present application, a non-volatile computer-readable storage medium is further provided. The non-volatile computer-readable storage medium has a computer program stored therein, and the computer program, when executed by a processor, implements the above-mentioned method for generating a speech enhancement model.

In another aspect of the present application, a speech enhancement method is further provided. The speech enhancement method includes: obtaining audio data; obtaining a speech enhancement model, where the speech enhancement model includes a first model and a second model, the first model is a deep neural network model, and resource occupation of the second model during operation is less than that occupied by the first model; processing the audio data by using the speech enhancement model to reduce or remove a noise signal in the audio data, where the processing includes: obtaining first audio data having a frame length of M from the audio data; inputting the first audio data into the first model for processing to obtain a first output result; obtaining second audio data having a frame length of N from the input audio, where the second audio data is subsequent to the first audio data, and N<M; and inputting the second audio data and the first output result into the second model for processing to obtain a second output result; and outputting the second output result as enhanced audio data.

In another aspect of the present application, a speech enhancement device is further provided. The speech enhancement device includes: a processor; and a storage apparatus, configured to store a computer program executable on the processor, where the computer program, when executed by the processor, causes the processor to perform the above-mentioned speech enhancement method.

In another aspect of the present application, a non-volatile computer-readable storage medium is further provided. The non-volatile computer-readable storage medium has a computer program stored therein, and the computer program, when executed by a processor, implements the above-mentioned speech enhancement method.

The above is an overview of the present application, and there may be simplifications, generalizations, and omissions of details, so those skilled in the art should recognize that this section is illustrative only and is not intended to limit the scope of the present application in any way. This Summary is neither intended to determine key features or necessary features of the claimed subject matter, nor intended to be used as an aid means in determining the scope of the claimed subject matter.

### BRIEF DESCRIPTION OF DRAWINGS

The foregoing and other features of the content of the present application will be more fully and clearly understood from the following specification and appended claims, taken in conjunction with the accompanying drawings. It can be understood that these accompanying drawings only depict some implementations of the content of the present application, and therefore should not be considered as limits to the scope of the content of the present application. By using the accompanying drawings, the content of the present application will be explained more clearly and in detail.

FIG. 1 is a structural block diagram illustrating a convolutional recurrent neural network.

FIG. 2 is a structural block diagram illustrating an RNNoise model.

FIG. 3 is a flowchart illustrating a method for generating a speech enhancement model according to an embodiment of the present application.

FIG. 4 is a flowchart illustrating a method for training a first model and a second model based on audio training data according to an embodiment of the present application.

FIG. 5 is a schematic diagram illustrating the first model and the second model processing respective audio data frames when the method of FIG. 4 is performed according to an embodiment of the present application.

FIG. 6 is a flowchart illustrating a method for training a first model and a second model based on audio training data according to another embodiment of the present application.

FIG. 7 is a schematic diagram illustrating the first model and the second model processing respective audio data frames when the method of FIG. 6 is performed according to an embodiment of the present application.

FIG. 8 is a flowchart illustrating a speech enhancement method according to an embodiment of the present application.

FIG. 9 is a schematic diagram illustrating the first model and the second model processing respective audio data frames when the method of FIG. 8 is performed according to an embodiment of the present application.

FIG. 10 is a schematic diagram illustrating the first model and the second model processing respective audio data frames when the method of FIG. 8 is performed according to another embodiment of the present application.

### DETAILED DESCRIPTION OF THE INVENTION

In the following detailed description, reference is made to the accompanying drawings which form a part hereof. In the accompanying drawings, similar symbols typically identify similar components, unless otherwise stated in the context. The illustrative embodiments described in the detailed description, accompanying drawings, and claims are not intended to be limiting. Other embodiments may be utilized, and other changes may be made, without departing from the spirit or scope of the subject matter of the present application. It can be understood that the aspects of the content of the present application, as generally described in the present application and illustrated in the accompanying drawings, can be configured, substituted, combined, and designed in a wide variety of different configurations, all of which explicitly form part of the content of the present application.

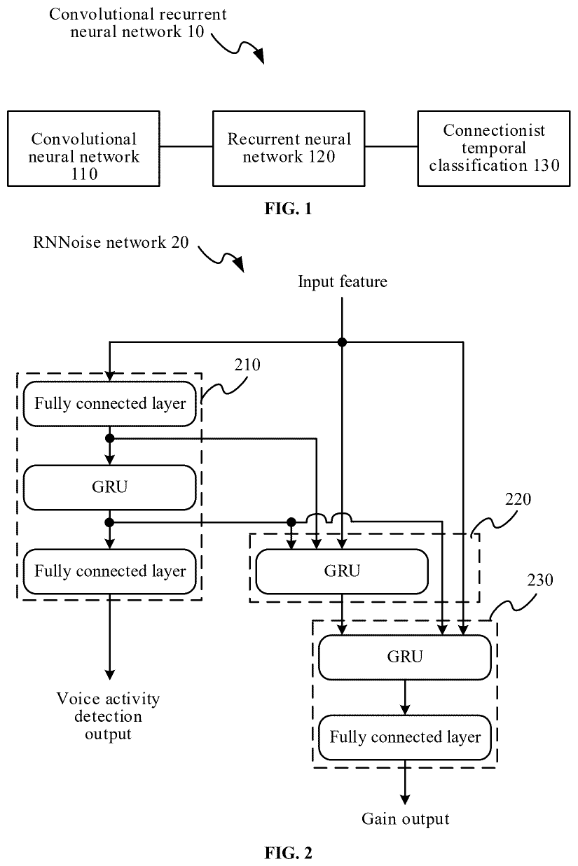

Referring to FIG. 1, a structural block diagram of a convolutional recurrent neural network (CRNN) 10 is illustrated.

The CRNN is a neural network obtained by combining a convolutional neural network (CNN) and a recurrent neural network (RNN). As shown in FIG. 1, the CRNN 10 generally includes a CNN module 110, an RNN module 120, and a connectionist temporal classification (CTC) module 130. Specifically, the CNN module 110 is configured to extract features from an audio data, the RNN module 120 (for example, using a long short-term memory (LSTM) neural unit) is configured to predict a sequence of the features of the audio data and output a predicted label distribution, and the CTC module 130 is configured to convert the label distribution obtained from the RNN module 120 into a final label sequence. A CTC algorithm is a loss calculation method. In a practical application, each layer or each module of the CRNN has various parameters for processing data, such as weighting coefficients and/or bias coefficients. After being trained with specific training data, the parameters of the CRNN can be determined, so as to perform a speech enhancement operation on similar speech data/signals.

Both time-domain information and frequency-domain information of a speech signal may be exhibited through a time-frequency spectrum. In order to remove or reduce a noise signal in the speech signal, the time-frequency spectrum of the speech signal may be processed with a time-frequency mask to obtain an enhanced time-frequency spectrum. For example, each element in the time-frequency mask can be considered as a ratio of a clean speech signal to a noise signal on different time-frequency units, and thus the enhanced time-frequency spectrum of the speech signal can be obtained by multiplying the time-frequency spectrum of the speech signal by the time-frequency mask. An output of the CRNN 10 in FIG. 1 is usually the time-frequency mask. In some examples, the output of the CRNN 10 is an ideal binary mask (IBM), and the output may be set to 0 or 1 according to a signal-to-noise ratio on each time-frequency unit in the speech signal. For example, When noise is dominant in a time-frequency unit, a value of the element corresponding to the time-frequency unit is set to 0, and when speech is dominant in a time-frequency unit, the value of the element corresponding to the time-frequency unit is set to 1. In some other examples, the output of the CRNN 10 is an ideal ratio mask (IRM). Different from the “0 or 1” strategy of the ideal binary mask, for the ideal ratio mask, an energy ratio between the speech and the noise is calculated to obtain a number ranging from 0 to 1, which is used as a value of an element corresponding to the time-frequency unit and is output. The ideal ratio mask is an evolution of the ideal binary mask, and can more accurately reflect a degree of suppression of noise by each time-frequency unit, thereby further improving a quality and an intelligibility of a separated speech. In some other embodiments, the output of the CRNN 10 may be an enhanced speech signal directly, which has been processed with the ideal binary mask or the ideal ratio mask.

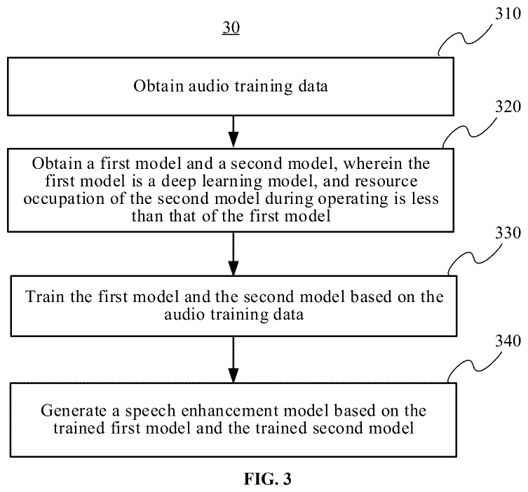

Referring to FIG. 2, a structural block diagram of an RNNoise model 20 is illustrated.

The RNNoise model 20 is another neural network model that can process data with relatively few processing parameters. Specifically, the RNNoise model 20 includes a voice activity detection module 210, a noise spectral estimation module 220, and a spectral subtraction module 230. The voice activity detection module 210 includes two fully connected layers and a gated recurrent unit (GRU) between the two fully connected layers, wherein the voice activity detection module 210 may receive input features (for example, spectral features) of an audio signal, detect the time when the inputted audio signal contains speech and the time when the inputted audio signal contains only noise, and output a detection result of the voice activity. The noise spectral estimation module 220 includes a GRU, wherein the noise spectral estimation module 220 may receive input features and estimate features of a noise spectrum with reference to information obtained from the voice activity detection module 210. The spectral subtraction module 230 includes a GRU and a fully connected layer, wherein the spectral subtraction module 230 may subtract a noise part from the inputted audio signal based on information obtained from the voice activity detection module 210 and the noise spectral estimation module 220, so as to obtain an enhanced speech signal. In the embodiment shown in FIG. 2, the enhanced speech signal is output by the spectral subtraction module 230 by making different frequency bands of the inputted audio signal have different gains. The GRUs and/or the fully connected layers of the RNNoise model may also have various parameters for processing data. Similarly, after being trained with specific training data, these parameters in the RNNoise model can be determined, so as to satisfy requirements of a speech enhancement processing. More details about the RNNoise model may refer to Jean-Marc Valin's article “A Hybrid DSP/Deep Learning Approach to Real-Time Full-Band Speech Enhancement” (arXiv:1709.08243[cs.SD], 2017), the content of which is incorporated herein by reference in its entirety.

It should be noted that, compared with the CRNN, the RNNoise model has fewer parameters (for example, less than 100,000), but has a worse speech enhancement effect. In contrast, the CRNN can achieve a better speech enhancement effect, but the CRNN usually has more than 1,000,000 parameters, which leads to more occupation of resources (for example, computing resources and/or storage resources) during its operation, and in turn leads to excessive power consumption of the device. In addition, the CRNN usually requires an input frame length ranging from 10 to 16 ms, and the frame length plus a delay caused by the operation itself usually results in its total end-to-end delay of approximately 20 ms. However, for devices with high real-time performance requirements such as hearing aids, once the end-to-end delay exceeds 10 ms, the processed sound will mix with the original sound, which will cause severe “echo” and loss of speech recognition. To reduce the delay, the input frame length of the CRNN should be reduced. However, the reduction of the frame length may cause an increasing of an operating frequency of the CRNN, which will further increase the power consumption of the device and is not conducive to deployment in an embedded system.

In order to solve problems existing in the prior art, a method for generating a speech enhancement model is provided in the present application. In this method, after audio training data is obtained, a first model which occupies more resources and a second model which occupies fewer resources are trained on the training data. In the training process, first, first audio data having a larger frame length is obtained from the input audio, and the first audio data is inputted into the first model for processing to obtain a first output result; then, second audio data, which is subsequent to the first audio data and has a smaller frame length, is obtained from the input audio, and the second audio data and the first output result are inputted into the second model for processing to obtain a second output result; and then, parameters of the first model and parameters of the second model are updated based on the second output result and a target output audio in the training data to obtain a trained first model and a trained second model. After the training, a speech enhancement model is generated based on the trained first model and the trained second model. The speech enhancement model generated by the method may integrate advantages of the two models, so that a better speech enhancement effect with low power consumption and low delay can be achieved.

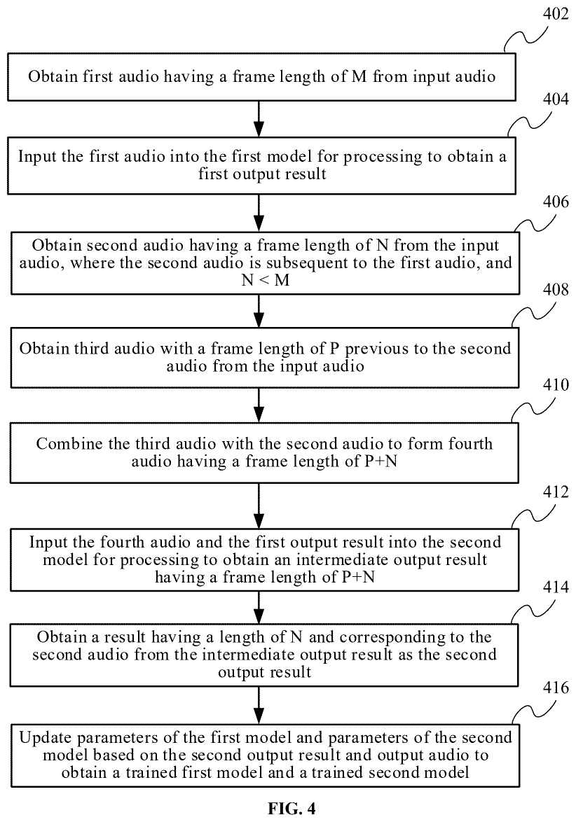

The method for generating a speech enhancement model of the present application will be described in detail below with reference to the accompanying drawings. FIG. 3 is a flowchart illustrating a method 30 for generating a speech enhancement model according to some embodiments of the present application. Specifically, the method 30 includes the following Steps 310 to 340.

In Step 310, audio training data is obtained, where the audio training data includes noisy input audio data and noiseless output audio data corresponding to the noisy input audio data.

In some embodiments, in the training data, the input audio may be a noisy person speech (Noisy Speech), and the output audio may be a noiseless person speech, or be referred to as a clean person speech (Clean Speech). For example, when preparing the training data, a plurality of original person speeches are first acquired to serve as the output audio; and then different noises are added into the original person speeches to obtain noisy speeches corresponding to the original person speeches to serve as the input audio. In another example, when preparing the training data, a near-field microphone close to a person may be configured to obtain clean person speeches to serve as the output audio, and meanwhile a far-field microphone far from the person may be configured to obtain noisy person speeches to serve as the input audio. In still another example, the training data includes noisy input audio data and noiseless output audio data, where the output audio is an audio generated by processing the input audio using various noise suppression or reduction techniques.

In some embodiments, the audio training data is obtained from open-source speech datasets such as the NOIZEUS dataset, the VOiCES dataset, and the CHIME dataset.

It can be understood that, in addition to the person speech, the speech serving as an object in the training data may be another type of sound such as an animal sound, a musical instrument sound, or an operating sound of a machine. In addition, it should be noted that the term “noiseless” in the present application does not require that the audio data does not contain other sounds different from the speech, but means that the clarity and intelligibility of the speech is improved relative to the “noisy” data, or that the noise of the audio data has been significantly attenuated, or that the clarity and intelligibility of the speech in the audio data reaches specific standards.

In Step 320, a first model and a second model are obtained, where the first model is a deep neural network model, and the second model occupies fewer resources during operation than the first model.

In some embodiments, the second model occupying fewer resources during operation than the first model may mean that, during operation, the second model occupies fewer storage resources (for example, random access memory, buffer, or other memory space occupied for storing model parameters or intermediate data) than the first model, and/or occupies fewer computing resources (for example, an amount of operations of processors, graphics cards, or other computing units occupied when performing speech enhancement on audio data per unit time) than the first model. It can be understood that, in some other embodiments, the occupied resource may not be limited to the above-mentioned storage resources or computing resources, and may include other hardware resources (for example, bus resources or power resources) of a hardware platform occupied during deployment.

In some embodiments, both the first model and the second model are deep neural network models, but a quantity of parameters of the second model are less than those of the first model, so that the resources occupied by the second model during operation is less than that occupied by the first model. For example, a ratio of the quantity of the parameters of the second model to the quantity of the parameters of the first model is less than ½, or preferably less than ⅕, for example, less than 1/800, less than 1/500, less than 1/200, less than 1/100, or less than 1/10. The present application does not limit a specific ratio between the quantities of parameters.

In an example, the first model may be the CRNN model shown in FIG. 1, which usually has more than 1,000,000 parameters, and the second model may be the RNNoise model shown in FIG. 2, which usually has less than 1,000,000 parameters, such as approximately 100,000 parameters. In another example, the first model may be the CRNN model shown in FIG. 1, and the second model may be a CRNN model generated by compressing the first model (for example, to ½ to 1/100 of its original scale). The aforementioned compression includes performing pruning and/or quantization operations on the parameters of the CRNN model.

It can be understood that each of the first model and the second model may be other deep neural network models suitable for speech enhancement, such as a convolutional neural network (CNN), a recurrent neural network (RNN), a deep belief network (DBN), a restricted Boltzmann machine (RBM), a fully connected network (FCN), a deep convolutional network (DCN), a long short-term memory (LSTM) network, or a GRU (GRU), which will not be listed herein.

In some other embodiments, the first model is a deep neural network model, and the second model is a hybrid model including a digital signal processing model and a simplified neural network model. The digital signal processing model can filter out a noise signal using a conventional digital signal processing technique, thereby achieving speech enhancement. For example, the digital signal processing model may perform speech enhancement based on spectral subtraction, wavelet transform, or Wiener (Wiener) filter techniques. The digital signal processing model usually has a smaller input frame length and occupies fewer resources, facilitating the finally obtained speech enhancement model to have the effects of low delay and low power consumption.

In some embodiments, the simplified neural network model in the second model may not have a function of speech enhancement, but may integrate the output result of the first model with the output result of the digital signal processing model, so that the second model on the whole is still able to achieve the speech enhancement function. For example, the second model may include a power spectrum estimation model and one or more fully connected layers. The power spectrum estimation model is a type of digital signal processing model, which can estimate an energy spectrum of a noise signal, so as to suppress or eliminate the noise signal in the audio data. Although the fully connected layer does not have the function of speech enhancement, the fully connected layer may integrate an output result of the power spectrum estimation model with the output result of the first model.

It can be understood that before the training, the parameters in the first model and the second model (for example, parameters of the deep neural network model, parameters of the digital signal processing model, or parameters of the fully connected layer) may have initial values. After being trained with the aforementioned training data, these parameters in the models may be updated.

In Step 330, the first model and the second model are trained based on the audio training data.

In some embodiments, first audio data having a frame length of M may be first obtained from the input audio, and the first audio data is inputted into the first model for processing to obtain a first output result. Then, second audio data having a frame length of N may be obtained from the input audio, where the second audio data is subsequent to the first audio data, and N<M. Next, the second audio data and the first output result may be inputted into the second model for processing to obtain a second output result. In this way, the parameters of the first model and the parameters of the second model may be updated based on the second output result and the output audio, thereby obtaining a trained first model and a trained second model.

The purpose of training the first model and the second model is to update the values of the parameters in the models to better achieve the purpose of speech enhancement. In the above embodiment, the step of inputting the first audio data into the first model for processing to obtain the first output result and the step of inputting the second audio data and the first output result into the second model for processing to obtain the second output result may be referred to as “forward propagation”, and the step of updating the parameters of the first model and the parameters of the second model based on the second output result and the output audio to obtain the trained first model and the trained second model may be referred to as “back propagation”. In some embodiments, the forward propagation and the back propagation processes may be controlled based on a loss function, to train the first model and the second model. For example, the loss function is optimized by using a gradient descent algorithm, so that its value can be minimized as much as possible. In some embodiments, the above-mentioned forward propagation and back propagation may be executed iteratively for a plurality of times. In the iterative execution processes, the updated values of the parameters of the trained first model and the trained second model that are generated in previous training are respectively assigned to and used by a first model to be trained and a second model to be trained in subsequent training. After the plurality of times of iterative execution, a difference between the second output result and the output audio in the training data may become smaller and smaller, thereby achieving the effect of optimizing the speech enhancement model.

More details about training the first model and the second model based on the audio training data may refer to specific embodiments described hereunder with reference to FIG. 4 to FIG. 7.

In Step 340, a speech enhancement model is generated based on the trained first model and the trained second model.

In some embodiments, in the above-described process of training the first model and the second model based on the audio training data, if the difference between the second output result and the output audio in the training data is less than a preset error value, or converges to a specific value, the training process may be ended, and the speech enhancement model is generated based on the trained first model and the trained second model.

It should be noted that speech is a complex time-varying signal, but usually has a strong correlation between time frames. This correlation may be reflected in the phenomenon of co-articulation when speaking. Multiple words in context often has an impact on a word that is being spoken, that is, there is a long-term correlation between the frames of the speech. In the embodiment of the present application, the first audio data processed by the first model is previous to the second audio data processed by the second model. Therefore, when the first output result generated by the first model and the second audio data both are inputted into the second model for processing, the correlation between the second audio data and the first audio data is taken into consideration, so that the second output result generated by the second model can achieve a better speech enhancement effect on the second audio data. In addition, in the embodiment of the present application, the frame lengths of the first audio data and the second audio data are M and N respectively, and N<M; and when the second output result of the second model is subsequently used as an output result of the entire speech enhancement model, the delay, compared with using only the first output result, can be significantly reduced.

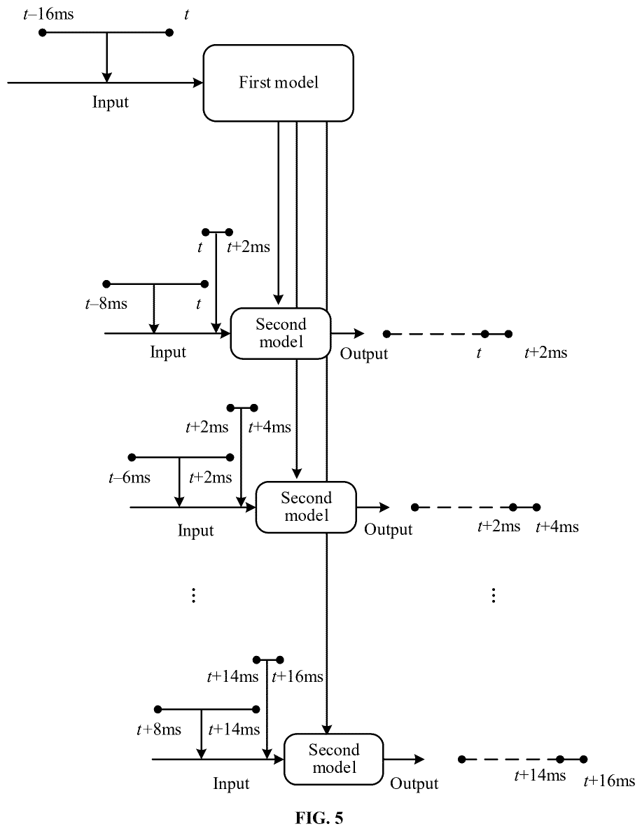

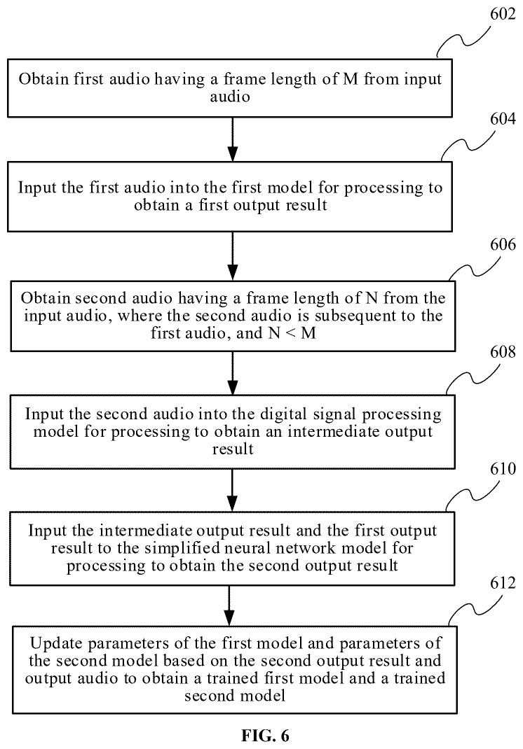

Referring to FIG. 4, a flowchart of a method for training a first model and a second model based on audio training data is illustrated according to an embodiment of the present application. Specifically, the method includes the following Steps 402 to 416. FIG. 5 is a schematic diagram illustrating the first model and the second model of processing respective audio data frames when the method of FIG. 4 is performed. In the examples of FIG. 4 and FIG. 5, both the first model and the second model are deep neural network models, and the resources occupied by the second model during operation is less than that occupied by the first model. For example, the first model may be the CRNN shown in FIG. 1, and the second model may be the RNNoise model shown in FIG. 2.

The method starts from Step 402, in which first audio data having a frame length of M is obtained from the input audio.

As mentioned above, the first model has a better speech enhancement effect, but the first model requires an audio signal having a large frame length as input, and the resource occupied by the first model during operation is more than that occupied by the second model. Therefore, in the embodiment of the present application, the first model is mainly configured to obtain coarse-grained information in the audio input with a large frame length, but the coarse-grained information is not directly used as the final input of the entire speech enhancement model and is inputted into the second model for further processing. Considering that there is a strong correlation between respective time frames of the input audio, the second model may further refine subsequent audio frames based on the coarse-grained information, thereby helping to improve the speech enhancement effect.

In some embodiments, the frame length M of the first audio data may range from 8 ms to 32 ms, for example, 10 ms, 16 ms, or 24 ms. As different types of deep neural network models have different requirements on the frame length of the input audio, a specific value of the frame length M of the first audio data in a specific application may be determined based on application requirements and characteristics of the first model.

For example, in the example of FIG. 5, the frame length M of the first audio data obtained from the input audio is 16 ms. Assuming that the current time is t and the second model processes the input audio subsequent to the time t, the first audio data obtained from the input audio may be an audio frame between the time t−16 ms and the time t. It can be understood that when the training just starts, i.e., t=0, there is no audio data between t−16 ms and t. Therefore, in this case, a blank audio (for example, all feature values of the audio are 0) may be used as the first audio data. In some other examples, a randomly generated audio or a preset audio may alternatively be used as the first audio data.

In Step 404, the first audio data is input into the first model for processing to obtain a first output result.

In the example of FIG. 5, the first model is a CRNN. After the first model processes the first audio data between t−16 ms and t, an ideal binary mask or an ideal ratio mask of the first audio data, or an enhanced speech signal processed using the ideal binary mask or the ideal ratio mask can be obtained.

In Step 406, second audio data having a frame length of N is obtained from the input audio, where the second audio data is subsequent to the first audio data, and N<M.

In some embodiments, the frame length N of the second audio data may range from 1 ms to 8 ms, for example, 2 ms, 4 ms, or 6 ms. A specific value of the frame length N of the second audio data in a specific application may be determined based on application requirements and the characteristics of the second model.

It should be noted that, in an embodiment of the present application, the second model needs to use the first result output by the first model to process the second audio data subsequent to the first audio data, but the correlation between the time frames of the speech has locality, and a delay of the second audio data subsequent to the first audio data should not be too long. Preferably, in some examples, if the first model processes the first audio data between t−M and t, the second audio data is an audio data between t and t+M.

In the example of FIG. 5, the first audio data is an audio frame between t−16 ms and t, and the second audio data is an audio frame between the time t and the time t+16 ms. If the frame length N of the second audio data is 2 ms, the second audio data obtained from the input audio may be an audio frame between the time t and the time t+2 ms.

The frame length of the second audio data is related to the output frame length of the subsequently generated speech enhancement model. For example, the frame length N of the second audio data is equal to the output frame length of the subsequently generated speech enhancement model, so that the frame length of the second audio data generally determines the power consumption and delay of the subsequently generated speech enhancement model. A smaller frame length of the second audio data indicates a shorter end-to-end delay of the speech enhancement model. However, a smaller frame length indicates a higher operating frequency of the speech enhancement model, which correspondingly increases the power consumption. For example, if the frame length of the second audio data is 2 ms, the end-to-end delay of the speech enhancement model is 2 ms plus a delay caused by the hardware operation. In addition, the speech enhancement model needs to be operated every 2 ms to continuously perform speech enhancement on the input audio. Therefore, in a specific application, the frame length of the second audio data can be set according to requirements on delay and power consumption of a scenario of the application. For example, for an application scenario requiring low delay, the frame length of the second audio data is set to be smaller, while for an application scenario requiring low power consumption, the frame length of the second audio data is set to be larger.

In Step 408, third audio data with a frame length of P previous to the second audio data is obtained from the input audio.

In the example of FIG. 5, both the first model and the second model are deep neural network models. Due to the strong correlation between the time frames of the input audio, the deep neural network model usually can achieve a good speech enhancement effect only when the frame length of the input audio is greater than a specific value. Although the second model is configured to process the second audio data having the frame length of N to obtain an output result having a frame length of N, the speech enhancement effect will be improved if the third audio data having the frame length of P previous to the second audio data is added into the input of the second model. Generally, the frame length P of the third audio data may be determined based on an requirement of the second model on the frame length of the input audio. For example, assuming that the second model can achieve a good speech enhancement effect only when the frame length of the input audio is greater than X, the frame length P of the third audio data should be preferably greater than or equal to (X−N).

Specifically, in the example of FIG. 5, the second audio data is an audio frame between the time t and the time t+2 ms, and the frame length of the obtained third audio data previous to the second audio data is 8 ms, that is, the third audio data is an audio frame between t−8 ms and t. It can be understood that when the training just starts, i.e., t=0, there is no audio data between t−8 ms and t. In this case, a blank audio may be used as the third audio data. In some other examples, a randomly generated audio or a preset audio may alternatively be used as the third audio data.

In Step 410, the third audio data is combined with the second audio data to form fourth audio data having a frame length of P+N.

In the example of FIG. 5, the third audio data between t−8 ms and t and the second audio data between t and t+2 ms are combined to form the fourth audio data having a frame length of 10 ms.

In Step 412, the fourth audio data and the first output result are input into the second model for processing to obtain an intermediate output result having a frame length of P+N.

In the example of FIG. 5, the fourth audio data of 10 ms between t−8 ms and t+2 ms, and the first output result which is obtained by the first model processing the first audio data between t−16 ms and t, are inputted into the second model for processing to obtain an intermediate output result having a frame length of 10 ms. The intermediate output result may be an ideal binary mask, an ideal ratio mask, or an enhanced speech signal processed using the ideal binary mask or ideal ratio mask.

In an example in which the second model is the RNNoise model shown in FIG. 2 and the input features received by the second model are spectral features of the audio signal, the fourth audio data and the first output result may be uniformly expressed as the spectral features that satisfies the input requirements of the RNNoise model, and then the spectral features are inputted into the RNNoise model for processing. As the input of the second model includes the coarse-grained information obtained after the first model processes the first audio data between t−16 ms and t, and also includes information about the audio between t−8 ms and t+2 ms, the processing is beneficial for achieving a better speech enhancement effect.

In Step 414, a result having a length of N and corresponding to the second audio data is obtained from the intermediate output result to serve as a second output result.

In some embodiments, although the second model processes the fourth audio data having a frame length of P+N and obtains an intermediate output result having a frame length of P+N, only a result having a length of N and corresponding to the second audio data is captured from the intermediate output result to serve as the second output result.

Specifically, in the example of FIG. 5, only an output result between t and t+2 ms is captured from the intermediate output result to serve as the second output result. In other words, each operation of the second model may be considered as only processing the newly inputted second audio data between t and t+2 ms, while the previous third audio data between t−8 ms and t is only used as auxiliary data to improve the speech enhancement effect.

In Step 416, the parameters of the first model and the parameters of the second model are updated based on the second output result and the output audio to obtain a trained first model and a trained second model.

In some embodiments, the frame length M of the first audio data is K times the frame length N of the second audio data (namely, M=K×N), where K is an integer greater than 1. In this way, in the process of training the first model and the second model based on the audio training data, K consecutive pieces of second audio data each having a frame length of N subsequent to the first audio data are obtained from the input audio, and the K pieces of second audio data may be sequentially inputted, together with the first output result, into the second model for processing to obtain K second output results. That is to say, the K consecutive pieces of second audio data each having a frame length of N subsequent to the first audio data are obtained, and Steps 406 to 414 in FIG. 4 are performed on each of the second audio data to obtain a corresponding second output result. Accordingly, the parameters of the first model and the parameters of the second model can be updated based on the K second output results and the output audio in the training data, thereby obtaining the trained first model and the trained second model.

Still taking FIG. 5 as an example, the frame length of 16 ms of the first audio data is eight times the frame length of 2 ms of the second audio data. Therefore, the second model may operate eight times to process eight pieces of second audio data between t and t+2 ms, between t+2 ms and t+4 ms, . . . , and between t+14 ms and t+16 ms respectively, and obtain results between t and t+2 ms, between t+2 ms and t+4 ms, . . . , and between t+14 ms and t+16 ms in the output respectively to serve as eight second output results. Then, the parameters of the first model and the parameters of the second model are updated based on the eight second output results and the corresponding output audio in the training data. In subsequent training processes, an audio of 16 ms between t and t+16 ms in the input audio may be sequentially obtained to serve as the first audio data, and eight pieces of 2 ms audios between t+16 ms and t+32 ms in the input audio are obtained to serve as the second audio data, to sequentially train the first model and the second model. The rest may be deduced by analogy, until the input audio in the audio training data ends.

It should be noted that, although the embodiment of the present application is described by taking an example in which the frame length M of the first audio data is an integral number of times the frame length N of the second audio data, the present application is not limited thereto. In some other embodiments, the frame length M of the first audio data is greater than the frame length N of the second audio data, but the frame length M of the first audio data is not an integral number of times the frame length N of the second audio data. For example, the frame length M of the first audio data is 16 ms, and the frame length N of the second audio data is 5 ms. It is still assumed that the first audio data is an audio frame between t−16 ms and t, and the second audio data may be an audio frame between the time t and the time t+5 ms. In addition, the second model may operate three times to process three pieces of second audio data between t and t+5 ms, between t+5 ms and t+10 ms, and between t+10 ms and t+15 ms in the input audio respectively, and obtain results between t and t+5 ms, between t+5 ms and t+10 ms, and between t+10 ms and t+15 ms in a corresponding output respectively to serve as three second output results. Then, the parameters of the first model and the parameters of the second model are updated based on the three second output results and the corresponding output audio in the training data. In subsequent training processes, an audio of 16 ms between t−1 ms to t+15 ms in the input audio may be obtained to serve as the first audio data, and three pieces of 5 ms audios between t+15 ms and t+30 ms in the input audio are obtained to serve as the second audio data, to sequentially train the first model and the second model. The rest may be deduced by analogy, until the input audio in the audio training data ends.

In some embodiments, a speech extraction model may be trained using, for example, an error back propagation algorithm or another existing training algorithm of an neural network. In a training process of the error back propagation algorithm, a difference between the K second output results generated in the training process and corresponding noiseless target output audio in the training data may be calculated, and then the difference may be back-propagated to adjust or update the parameters of the first model and the parameters of the second model. The error back propagation algorithm may be performed for a plurality of times along with the iterative operations of the above training steps until a training stop condition is satisfied.

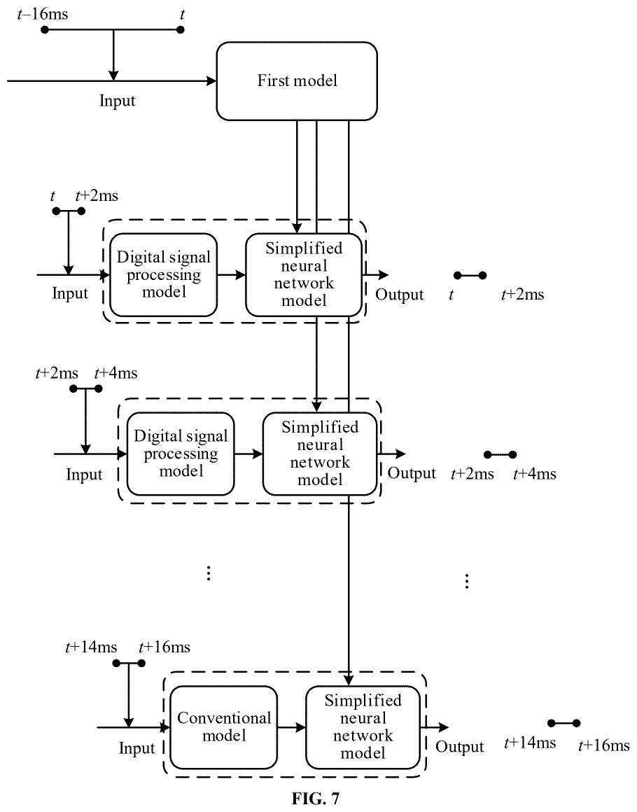

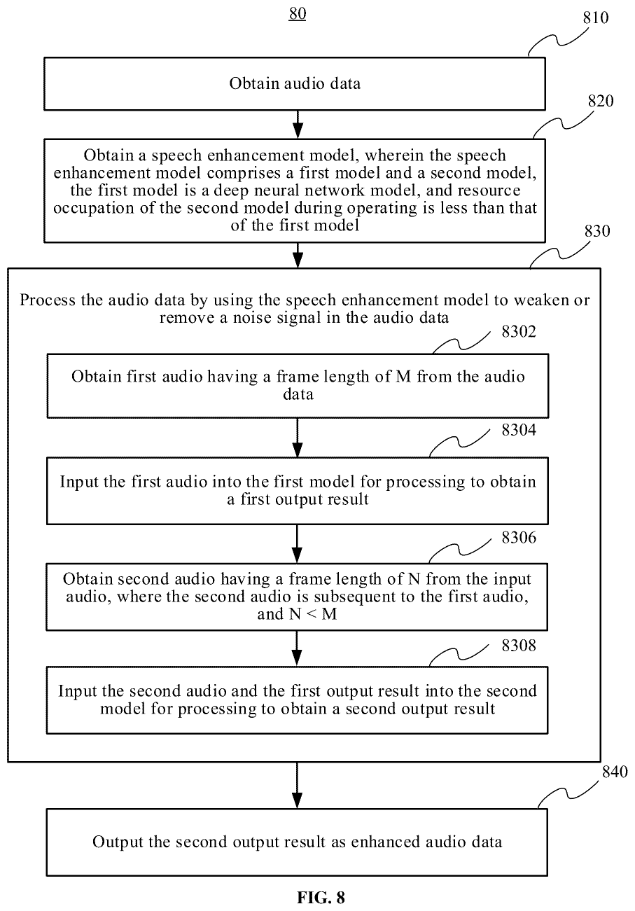

Referring to FIG. 6, a flowchart of a method for training a first model and a second model based on audio training data is illustrated according to another embodiment of the present application. Specifically, the method includes the following Steps 602 to 612. FIG. 7 is a schematic diagram illustrating the first model and the second model processing respective audio data frames when the method of FIG. 6 is performed. In the example of FIG. 6 and FIG. 7, the first model is a deep neural network model, and the second model is a hybrid model including a digital signal processing model and a simplified neural network model. For example, the first model may be the CRNN shown in FIG. 1, and the second model may include a power spectrum estimation model and one or more fully connected layers.

Some embodiments of the method for training the first model and the second model will be described below with reference to FIG. 6 and FIG. 7. It should be noted that the method for training the first model and the second model shown in FIG. 6 and FIG. 7 may have the same or similar parts as the method for training the first model and the second model shown in FIG. 4 and FIG. 5. The same or similar parts will not be described in detail hereunder, but a difference between the two methods will be emphasized.

In Step 602, first audio data having a frame length of M is obtained from an input audio.

In the example of FIG. 7, an audio frame having a length of 16 ms and between t−16 ms and t is obtained from the input audio to serve as the first audio data.

In Step 604, the first audio data is input into the first model for processing to obtain a first output result.

In the example of FIG. 7, the first audio data between t−16 ms and tis inputted into the first model for processing to obtain the first output result.

In Step 606, second audio data having a frame length of N is obtained from the input audio, where the second audio data is subsequent to the first audio data, and N<M.

In the example of FIG. 7, an audio frame having a length of 2 ms and between tto t+2 ms is obtained to serve as the second audio data.

In Step 608, the second audio data is input into the digital signal processing model for processing to obtain an intermediate output result.

Different from the second model shown in FIG. 4 and FIG. 5, in the example of FIG. 6 and FIG. 7, the second model is a hybrid model including a digital signal processing model and a simplified neural network model. The digital signal processing model can filter out or suppress a noise signal in the input audio by using a conventional digital signal processing technique. The digital signal processing model has fewer parameters, and requires a smaller frame length of the input audio compared with the deep neural network model, which is beneficial for reducing the delay in the finally generated speech enhancement model. The simplified neural network model may be a neural network from which a plurality of hidden layers such as GRUs, long short-term memory units, and/or convolutional units are removed and in which only units (for example, one or more convolutional layers) having an ability to integrate the output result of the first model with the output result of the digital signal processing model are retained. Generally, the simplified neural network model has no speech enhancement function, and is only configured to integrate the output result of the first model with the output result of the digital signal processing model. However, the present application is not limited thereto. In some embodiments, the simplified neural network model may have a speech enhancement function, for example, may have relatively few processing parameters.

In the example of FIG. 7, after the second audio data between t and t+2 ms is inputted into the digital signal processing model for processing, the noise signal in the second audio data may be filtered out or suppressed to obtain an intermediate output result having a length of 2 ms.

In Step 610, the intermediate output result and the first output result is input into the simplified neural network model for processing to obtain a second output result.

In the example of FIG. 7, the intermediate output result corresponding to the second audio data between t and t+2 ms, and the first output result generated by the first model both are inputted into the simplified neural network model for processing to obtain the second output result having a frame length of 2 ms. The input of the simplified neural network model includes the coarse-grained information obtained after the first model processes the first audio data between t−16 ms and t, and also includes fine-grained information about the audio between t and t+2 ms. Therefore, the processing is beneficial for achieving a better speech enhancement effect.

In Step 612, the parameters of the first model and the parameters of the second model are updated based on the second output result and the output audio to obtain a trained first model and a trained second model.

In the example of FIG. 7, the frame length of 16 ms of the first audio data is eight times the frame length of 2 ms of the second audio data. Therefore, the second model may operate eight times to process eight pieces of second audio data between t and t+2 ms, between t+2 ms and t+4 ms, . . . , and between t+14 ms and t+16 ms respectively, and obtain eight second output results. Then, the parameters of the first model, the parameters of the digital signal processing model, and the parameters of the simplified neural network model are updated based on the eight second output results and the corresponding output audio in the training data.

It should be noted that the frame length of each audio in the above examples is only used as an example (for example, the frame length of the first audio data is 16 ms, and the frame length of the second audio data is 2 ms). However, the present application is not limited thereto. In other examples, other frame lengths may be used to train the first model and the second model based on specific application scenarios and characteristics of the first model and the second model.

In addition, it should be further noted that the method for training the first model and the second model of the present application using the forward propagation and the back propagation methods of the present application has been described in detail hereabove with reference to FIG. 4 to FIG. 7. However, the present application is not limited thereto. In some other examples, other training algorithms capable of updating the parameters of the first model and the parameters of the second model to achieve a better speech enhancement effect may be used.

In another aspect of the present application, a speech enhancement method is further provided. In this method, the speech enhancement model generated in the foregoing embodiments is used to enhance the obtained audio data. Specifically, the speech enhancement model generated in the foregoing embodiments may be used in various audio devices. For example, the speech enhancement model may be used in a speech recognition system. For another example, the speech enhancement model may be used in a hearing aid. Different audio devices may have different requirements for the speech enhancement effect. However, whether the audio device is a speech recognition device or a hearing aid device, the audio device needs to maintaining integrity and clarity of speech as much as possible while removing speech noise. In an embodiment of the present invention, the speech enhancement model may be applied to electronic devices with an audio acquisition function and/or an audio output function, such as hearing aids, earphones, mobile communication terminals, and smart home products.

The speech enhancement method of the present application will be described below with reference to the accompanying drawings. FIG. 8 shows a flowchart of a speech enhancement method 80 according to some embodiments of the present application. Specifically, the method 80 includes the following Steps 810 to 840.

In Step 810, an audio data is obtained.

In some embodiments, the audio data may be obtained by an audio acquisition unit of an audio device. For example, when receiving a user's speech enhancement request, a microphone of the audio device is turned on to acquire the audio data.

Since there are various types of noises in the surrounding environment of the audio device, such as white noise produced by the nature, man-made burst noises, and reverberations produced by room reflection, the noises are also mixed in the speech signal received by the audio acquisition unit. The mixed noise may affect the quality and intelligibility of the received speech, thereby affecting the subsequent processing of speech units. The main purpose of speech enhancement is to denoise the noisy audio data. By using the speech enhancement, various interference signals can be effectively suppressed, and a target speech signal can be enhanced. The target speech signal may be a person speech, an animal sound, a musical instrument sound, a machine operating sound, or the like.

In Step 820, a speech enhancement model is obtained, where the speech enhancement model includes a first model and a second model, the first model is a deep neural network model, and resources occupied by the second model during operation is less than that occupied by the first model.

In some embodiments, both the first model and the second model are deep neural network models, and the parameters of the second model are fewer than the parameters of the first model. For example, a ratio of a quantity of the parameters of the second model to a quantity of the parameters of the first model is less than ½, preferably less than ⅕. In some embodiments, the first model is a CRNN model, and the second model is an RNNoise model.

In some embodiments, the first model is a deep neural network model, and the second model is a hybrid model including a digital signal processing model and a simplified neural network model. For example, the second model includes a power spectrum estimation model and one or more fully connected layers.

The speech enhancement model may be a speech enhancement model generated by using the method for generating a speech enhancement model described in the above embodiments. Therefore, more details about the speech enhancement model may refer to the above descriptions made with reference to FIG. 3 to FIG. 7, and will not be elaborated herein.

In Step 830, the audio data is processed by using the speech enhancement model to reduce or remove a noise signal in the audio data.

In the example of FIG. 8, Step 830 further includes the following Steps 8302 to 8308. In Step 8302, first audio data having a frame length of M is obtained from the audio data. In Step 8304, the first audio data is input into the first model for processing to obtain a first output result. In Step 8306, second audio data having a frame length of N is obtained from the input audio, where the second audio data is subsequent to the first audio data, and N<M. In Step 8308, the second audio data and the first output result are input into the simplified neural network model for processing to obtain a second output result.

In Step 840, the second output result is output to serve as an enhanced audio data.

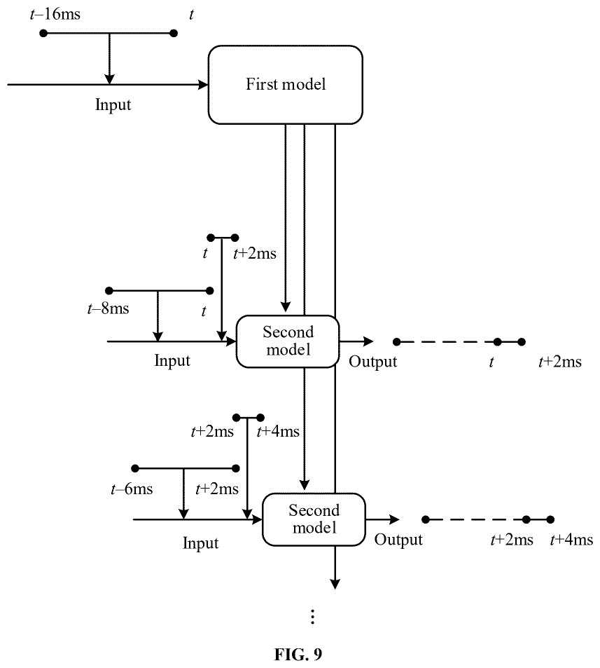

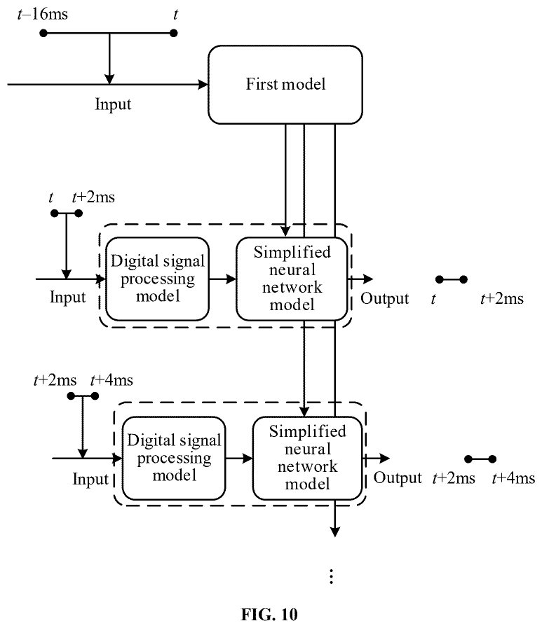

The Steps 830 and 840 of processing audio data using the speech enhancement model and obtaining the enhanced audio data will be further described below with reference to specific examples in FIG. 9 and FIG. 10.

In the example of FIG. 9, both the first model and the second model are deep neural network models, and resources occupied by the second model during operation is less than that occupied by the first model. For example, the first model may be the CRNN shown in FIG. 1, and the second model may be the RNNoise model shown in FIG. 2.

Specifically, the first audio data having a frame length of 16 ms is first obtained from the audio data. Assuming that the current time is t and the second model processes the audio data subsequent to the time t, the first audio data obtained from the audio data may be an audio frame between the time t−16 ms and the time t. Then, the first audio data of 16 ms between the time t−16 ms and the time t is inputted into the first model for processing to obtain a first output result. For the second model, an audio frame of 2 ms between the time t and the time t+2 ms is obtained from the audio data to serve as second audio data. In addition, an audio frame of 8 ms between the time t−8 ms and the time t is obtained from the audio data as third audio data, and the third audio data is combined with the second audio data to form fourth audio data having a frame length of 10 ms. Then, both the fourth audio data and the first output result of the first model are inputted into the second model for processing to obtain an intermediate output result having a frame length of 10 ms. Finally, a result having a length of 2 ms and corresponding to the second audio data is obtained from the intermediate output result to serve as a second output result. The second output result is an enhanced audio data generated after reducing or removing the noise signal in the audio data. Next, seven pieces of second audio data between t+2 ms and t+4 ms, . . . , between t+14 ms and t+16 ms may continue to be obtained, and are inputted sequentially together with the first output result into the second model for similar processing, to output corresponding enhanced audio data respectively. After the second model completes the processing of the eight consecutive pieces of second audio data between t and t+16 ms, the first model may be started again to continue to process an audio between t and t+16 ms in the audio data to generate a new first output result and transmit the new first output result to the second model. The second model then uses the new first output result to process eight pieces of second audio data between t+16 ms and t+32 ms to obtain a new enhanced audio data. By analogy, the speech enhancement processing is continuously performed on the audio data obtained by the audio acquisition unit.

In the example of FIG. 10, the first model is a deep neural network model, and the second model is a hybrid model including a digital signal processing model and a simplified neural network model. For example, the first model may be the CRNN shown in FIG. 1, and the second model may include a power spectrum estimation model and one or more fully connected layers.

Specifically, first audio data having a frame length of 16 ms is first obtained from the audio data. Assuming that the current time is t and the second model processes the audio data subsequent to the time t, the first audio data obtained from the audio data may be an audio frame between the time t−16 ms and the time t. Then, the first audio data of 16 ms between the time t−16 ms and the time t is inputted into the first model for processing to obtain a first output result. For the digital signal processing model in the second model, an audio frame of 2 ms between the time t and the time t+2 ms is obtained from the audio data to serve as the second audio data. Then, after the second audio data between t and t+2 ms is inputted into the digital signal processing model for processing, a noise signal in the second audio data may be filtered out or suppressed to obtain an intermediate output result of 2 ms. Next, both the intermediate output result corresponding to the second audio data between t and t+2 ms, and the first output result generated by the first model are inputted into the simplified neural network model for processing, to obtain a second output result having a frame length of 2 ms. The second output result is an enhanced audio data generated after reducing or removing the noise signal in the audio data. Next, seven pieces of second audio data between t+2 ms and t+4 ms, . . . , t+14 ms and t+16 ms may continue to be obtained, and are inputted into the digital signal processing model to obtain seven intermediate output results. Then, the seven intermediate output results are sequentially inputted, together with the first output result, into the simplified neural network model for processing to obtain seven second output results. After the second model completes the processing of eight consecutive pieces of second audio data between t and t+16 ms, the first model may be started again to continue to process the audio between t and t+16 ms in the audio data to generate a new first output result and transmit the new first output result to the second model. The second model then uses the new first output result to process eight pieces of second audio data between t+16 ms and t+32 ms to obtain a new enhanced audio data. By analogy, the speech enhancement processing is continuously performed on the audio data obtained by the audio acquisition unit.

It should be noted that in the embodiments described above with reference to FIG. 9 and FIG. 10, the frame length of each audio is only used as an example (for example, the frame length of the first audio data is 16 ms, and the frame length of the second audio data is 2 ms). However, the present application is not limited thereto. In other examples, other frame lengths may be used to train the first model and the second model based on specific application scenarios and characteristics of the first model and the second model. In addition, the speech enhancement method described above with reference to FIG. 8 to FIG. 10 may have the same or similar parts as the method for generating a speech enhancement model described in the previous embodiments. Therefore, more details about the speech enhancement method may refer to the method for generating a speech enhancement model described above with reference to FIG. 3 to FIG. 7, and will not be elaborated herein.

With reference to the above embodiments, it can be seen that the speech enhancement model of the present application combines two models with different resource occupation, and is deployed on the corresponding speech enhancement device after retraining. A larger model that occupies more resources can obtain coarse-grained information from an audio data having a larger frame length, and then a smaller model that occupies fewer resources uses the coarse-grained information generated by the larger model to refine an audio data having a smaller frame length. Therefore, the speech enhancement model of the present application can reduce delay and reduce power consumption while taking the speech enhancement effect into account. Taking the speech enhancement method shown in FIG. 9 as an example, the enhanced audio data is output at a frequency of once every 2 ms, and thus, for an audio data having a frame length of 16 ms, the larger model (namely, the first model) that occupies more resources needs to operate once, and the smaller model (namely, the second model) that occupies fewer resources needs to operate eight times. By comparison, assuming that the larger model that occupies more resources is used alone to output the enhanced audio data at a frequency of once every 2 ms, it needs to operate the larger model eight times for the audio data having a frame length of 16 ms. Because the larger model has more parameters (for example, more than 1,000,000) and the resource occupation is larger during operation, the power consumption of the speech device is significantly increased. By comparison again, assuming that the smaller model that occupies fewer resources is used alone to output the enhanced audio data at a frequency of once every 2 ms, it needs to operate the smaller model eight times for the audio data having a frame length of 16 ms. However, the small model has fewer parameters, and accordingly has a speech enhancement effect significantly worse than that of the speech enhancement model of the present application.

In some embodiments, the present application further provides a non-volatile computer-readable storage medium, having stored therein computer-executable instructions that, when executed by a processor, causing the processor to perform the steps of the method shown in FIG. 3, FIG. 4, and/or FIG. 6, so as to implement the method for generating the speech enhancement model in the above embodiments of the present application. In some embodiments, the present application further provides a device for generating a speech enhancement model. The device includes a processor and a storage apparatus for storing computer programs executable by the processor, wherein, when executed by the processor, the computer program may implement the method for generating the speech enhancement model in the above embodiments of the present application.

In some other embodiments, the present application further provides a non-volatile computer-readable storage medium having stored therein computer-executable instructions that, when executed by a processor, causing the processor to perform the steps of the method shown in FIG. 8, so as to implement the speech enhancement method in the above embodiments of the present application. In some embodiments, the present application further provides a speech enhancement device. The device includes a processor and a storage apparatus for storing computer programs executable by the processor, wherein, when executed by the processor, the computer program may implement the speech enhancement method in the above embodiments of the present application.

In addition, the embodiments of the present invention may be implemented by hardware, software, or a combination of software and hardware. The hardware part may be implemented by using dedicated logic, and the software part may be stored in a memory and can be executed by an appropriate instruction execution system such as a microprocessor or a dedicated design hardware. A person of ordinary skill in the art may understand that the foregoing devices and methods may be implemented by using computer-executable instructions and/or being included in processor control codes, and such codes may be provided by, for example, a carrier media such as a disk, a CD or a DVD-ROM, a programmable memory such as a read-only memory (firmware), or a data carrier such as an optical or electronic signal carrier. The device and its modules of the present invention may be implemented by hardware circuits such as very large scale integration circuits or gate arrays, semiconductors such as logic chips or transistors, or programmable hardware devices such as field programmable gate arrays or programmable logic devices, or may be implemented by software executed by various types of processors, or may be implemented by a combination of the above-mentioned hardware circuits and software, such as firmware.

It should be noted that although several steps or modules of the method, device, and storage medium for generating a speech enhancement model, and several steps or modules of the speech enhancement method, device, and storage medium have been mentioned in the above detailed description, such division is merely exemplary rather than mandatory. Actually, according to the embodiments of the present application, the features and functions of two or more modules described above may be embodied in one module. Conversely, the feature or function of one module described above may be further divided and embodied by a plurality of modules.

Those of ordinary skill in the art can understand and implement other changes to the disclosed embodiments by studying the description, the disclosed content, the drawings, and the appended claims. In the claims, the term “comprising” does not exclude other elements and steps, and the term “a” or “an” does not exclude a plurality. In an actual application of the present application, one component may perform functions of a plurality of technical features cited in the claims. Any reference signs in the claims should not be construed as limiting the scope.

1. A method for generating a speech enhancement model, comprising:
obtaining audio training data, wherein the audio training data comprises noisy input audio data and noiseless output audio data corresponding to the noisy input audio data;
obtaining a first model and a second model, wherein the first model is a deep neural network model, and resources occupied by the second model during operation is less than that occupied by the first model;
training the first model and the second model based on the audio training data, wherein the training comprises:
obtaining first audio data having a frame length of M from the input audio data:
inputting the first audio data into the first model for processing to obtain a first output result;
obtaining second audio data having a frame length of Nfrom the input audio data, wherein the second audio data is subsequent to the first audio data, and N<M;
inputting the second audio data and the first output result into the second model for processing to obtain a second output result; and
updating parameters of the first model and parameters of the second model based on the second output result and the output audio data to obtain the trained first model and the trained second model; and
generating a speech enhancement model based on the trained first model and the trained second model.

2. The method of claim 1, wherein the second model is a deep neural network model, and the parameters of the second model are fewer than the parameters of the first model.

3. The method of claim 2, wherein a ratio of a quantity of the parameters of the second model to a quantity of the parameters of the first model is less than 1/2.

4. The method of claim 2, wherein the first model is a convolutional recurrent neural network model, and the second model is an RNNoise model.

5. The method of claim 2, wherein training the first model and the second model based on the audio training data further comprises:
obtaining third audio data with a frame length of P previous to the second audio data from the input audio data; and
combining the third audio data with the second audio data to form fourth audio data having a frame length of P+N,
wherein inputting the second audio data and the first output result into the second model for processing to obtain the second output result comprises:
inputting the fourth audio data and the first output result into the second model for processing to obtain an intermediate output result having a frame length of P+N; and
obtaining a result having a length of N and corresponding to the second audio data from the intermediate output result to serve as the second output result.

6. The method of claim 1, wherein the second model comprises a digital signal processing model and a simplified neural network model.

7. The method of claim 6, wherein the second model comprises a power spectrum estimation model and a fully connected layer.

8. The method of claim 6, wherein inputting the second audio data and the first output result into the second model for processing to obtain the second output result comprises:
inputting the second audio data into the digital signal processing model for processing to obtain an intermediate output result; and
inputting the intermediate output result and the first output result to the simplified neural network model for processing to obtain the second output result.

9. The method of claim 1, wherein M=K×N, and K is an integer greater than 1; and
wherein, during training the first model and the second model based on the audio training data, K consecutive pieces of second audio data each having a frame length of N subsequent to the first audio data are obtained from the input audio data, the K pieces of second audio data are sequentially inputted, together with the first output result, into the second model for processing to obtain K second output results, and the parameters of the first model and the parameters of the second model are updated based on the K second output results and the output audio data to obtain the trained first model and the trained second model

10. (canceled)

11. The method of claim 1, wherein a step of training the first model and the second model based on the audio training data is executed iteratively for a plurality of times, wherein in an iterative execution process, updated values of the parameters of the trained first model and updated values of the parameters of the trained second model that are generated in a previous training are respectively assigned to the first model to be trained and second model to be trained for using in a subsequent training.

12. (canceled)

13. (canceled)

14. A speech enhancement method, comprising:
obtaining an audio data;
obtaining a speech enhancement model, wherein the speech enhancement model comprises a first model and a second model, the first model is a deep neural network model, and resources occupied by the second model during operation is less than that occupied by the first model;
processing the audio data by using the speech enhancement model to reduce or remove a noise signal in the audio data, wherein the processing comprises:
obtaining first audio data having a frame length of M from the audio data;
inputting the first audio data into the first model for processing to obtain a first output result;
obtaining a second audio data having a frame length of N from the input audio, wherein the second audio data is subsequent to the first audio data, and N<M; and
inputting the second audio data and the first output result into the second model for processing to obtain a second output result; and
outputting the second output result as an enhanced audio data.

15. The speech enhancement method of claim 14, wherein the second model is a deep neural network model, and parameters of the second model are fewer than parameters of the first model.

16. The speech enhancement method of claim 15, wherein a ratio of a quantity of the parameters of the second model to a quantity of the parameters of the first model is less than ½.

17. The speech enhancement method of claim 15, wherein the first model is a convolutional recurrent neural network model, and the second model is an RNNoise model.

18. The speech enhancement method of claim 15, wherein processing the audio data by using the speech enhancement model to reduce or remove the noise signal in the audio data further comprises:
obtaining third audio data with a frame length of P previous to the second audio data from the input audio; and
combining the third audio data with the second audio data to form fourth audio data having a frame length of P+N,
wherein inputting the second audio data and the first output result into the second model for processing to obtain the second output result comprises:
inputting the fourth audio data and the first output result into the second model for processing to obtain an intermediate output result having a frame length of P+N; and
obtaining a result having a length of N and corresponding to the second audio data from the intermediate output result to serve as the second output result.

19. The speech enhancement method of claim 14, wherein the second model comprises a digital signal processing model and a simplified neural network model.

20. The speech enhancement method of claim 19, wherein the second model comprises a power spectrum estimation model and a fully connected layer.

21. The speech enhancement method of claim 19, wherein inputting the second audio data and the first output result into the second model for processing to obtain the second output result comprises:
inputting the second audio data into the digital signal processing model for processing to obtain an intermediate output result; and
inputting the intermediate output result and the first output result to the simplified neural network model for processing to obtain the second output result.

22. The speech enhancement method of claim 14, wherein M=K×N, and K is an integer greater than 1; and
wherein during processing the audio data by using the speech enhancement model, K consecutive pieces of second audio data each having a frame length of N subsequent to the first audio data are obtained from the audio data, and the K pieces of second audio data are sequentially inputted, together with the first output result, into the second model for processing to obtain K second output results.

23. (canceled)

24. A speech enhancement device, comprising:
a processor; and
a storage apparatus configured to store a computer program executable by the processor,
wherein the computer program, when executed by the processor, causes the processor to perform the speech enhancement method of claim 14.

25. (canceled)
